(19) United States
(12) Patent Application Publication
(10) Pub. No.: US 2019/0142661 A1
(43) Pub. Date: May 16, 2019

(54) STEERABLE CARRY-ON PUSH AIDS FOR WHEELCHAIRS

(71) Applicant: TZORA ACTIVE SYSTEMS LTD, Kibbutz Tzora (IL)

(72) Inventors: Adi SHEMER, Kibbutz Tzora (IL); Michael GLAZMAN, Jerusalem (IL)

(73) Assignee: TZORA ACTIVE SYSTEMS LTD, Kibbutz Tzora (IL)

(21) Appl. No.: 16/190,177

(22) Filed: Nov. 14, 2018

Related U.S. Application Data
(63) Continuation of application No. 62/585,563, filed on Nov. 14, 2017.

(51) Int. Cl. A61G 5/04

(52) U.S. Cl. CPC A61G 5/047

(57) ABSTRACT

Carry-on push aids and methods for propelling a wheelchair are provided. Carry-on push aids comprise a base with three, four or more wheels which is configured to securely engage the wheelchair and to mechanically support the wheelchair. The base comprises at least one drive unit powering one or more of the wheels, and the carry-on push aids further comprise a steering unit connected to and configured to control one or more of the wheels. For example, carry-on push aids may have rear powered wheels which operationally replace the securely engaged rear wheelchair wheels, and two front steerable wheels. The spacing between carry-on push aid rear wheels and between steering unit handles is wide enough to provide easy steering of the wheelchair supporting heavy patients, using the carry-on push aid handles only.

### CROSS REFERENCE TO RELATED APPLICATIONS

This application claims the benefit of U.S. Provisional Patent Application No. 62/585,563, filed on Nov. 14, 2017, which is incorporated herein by reference in its entirety.

### BACKGROUND OF THE INVENTION

### 1. Technical Field

The present invention relates to the field of push aids and, more particularly, to push aids for wheelchairs.

### 2. Discussion of Related Art

Prior art push aids for wheelchairs are attachable thereto and provide additional propulsive power to assist a user who is pushing the wheelchair.

### SUMMARY OF THE INVENTION

The following is a simplified summary providing an initial understanding of the invention. The summary does not necessarily identify key elements nor limits the scope of the invention, but merely serves as an introduction to the following description.

One aspect of the present invention provides a carry-on push aid for propelling a wheelchair, the carry-on push aid comprising: a base comprising at least three wheels and at least one drive unit powering at least a powered one of the wheels, wherein the base is configured to securely engage the wheelchair and to mechanically support the wheelchair, and a steering unit connected to and configured to control at least a steered one of the wheels.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high-level schematic illustration of a carry-on push aid for propelling a wheelchair, according to some embodiments of the invention.

FIGS. 2 and 3 are illustrations of carry-on push aid configurations and of a method of using carry-on push aids to propel the wheelchair, according to some embodiments of the invention.

FIG. 4 is a high-level schematic top view illustration of a steering unit of the carry-on push aid, according to some embodiments of the invention.

FIG. 5 is a high-level schematic side view illustration of the wheelchair and the carry-on push aid, according to some embodiments of the invention.

FIG. 6 is an illustration of a prototype of the carry-on push aid in a non-operational state, with opened cover, according to some embodiments of the invention.

FIGS. 7A-7D illustrate a prior art push aid and its use.

FIG. 8 is a high-level flowchart illustrating a method, according to some embodiments of the invention.

FIG. 9 is a high-level schematic side-view illustration of the carry-on push aid propelling a large-wheel wheelchair, according to some embodiments of the invention.

FIG. 10 is a high-level schematic perspective view illustration of a drive unit of the carry-on push aid, according to some embodiments of the invention.

FIG. 11 is a high-level schematic sectional side-view illustration of the secure engagement of the wheelchair by the carry-on push aid, according to some embodiments of the invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Carry-on push aids and methods for propelling a wheelchair are provided. Carry-on push aids comprise a base with three, four or more wheels which is configured to securely engage the wheelchair. The base comprises one, two or more motors powering one or more of the wheels and the carry-on push aids further comprise a steering unit connected to and configured to control one or more of the wheels. For example, carry-on push aids may have rear powered wheels which operationally replace the fixated rear wheelchair wheels, and two front steerable wheels. The spacing between the rear wheels and between steering unit handles may be wide enough to provide easy steering of the wheelchair support heavy patients, using the carry-on push aid handles only.

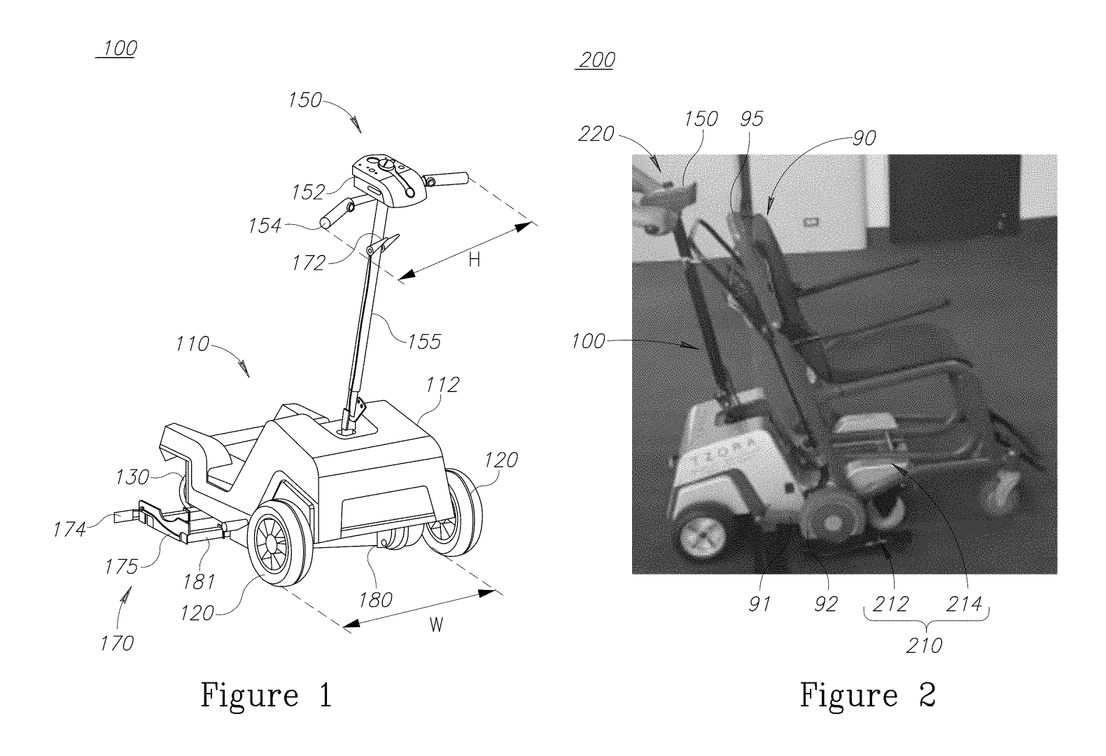

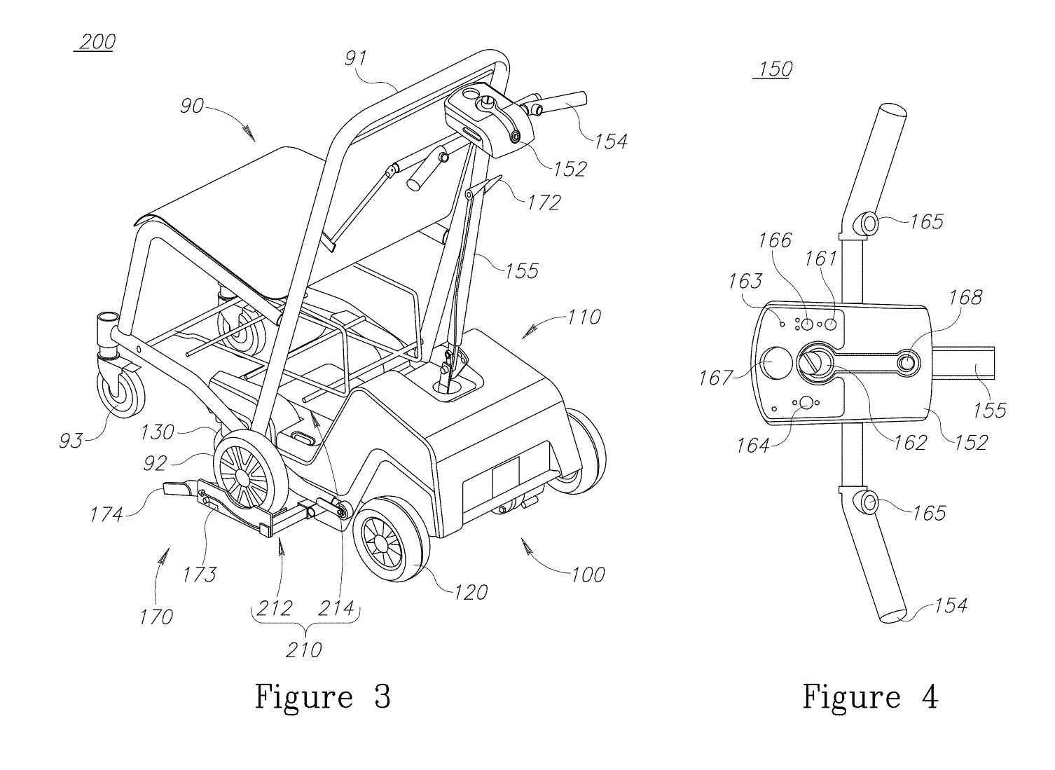

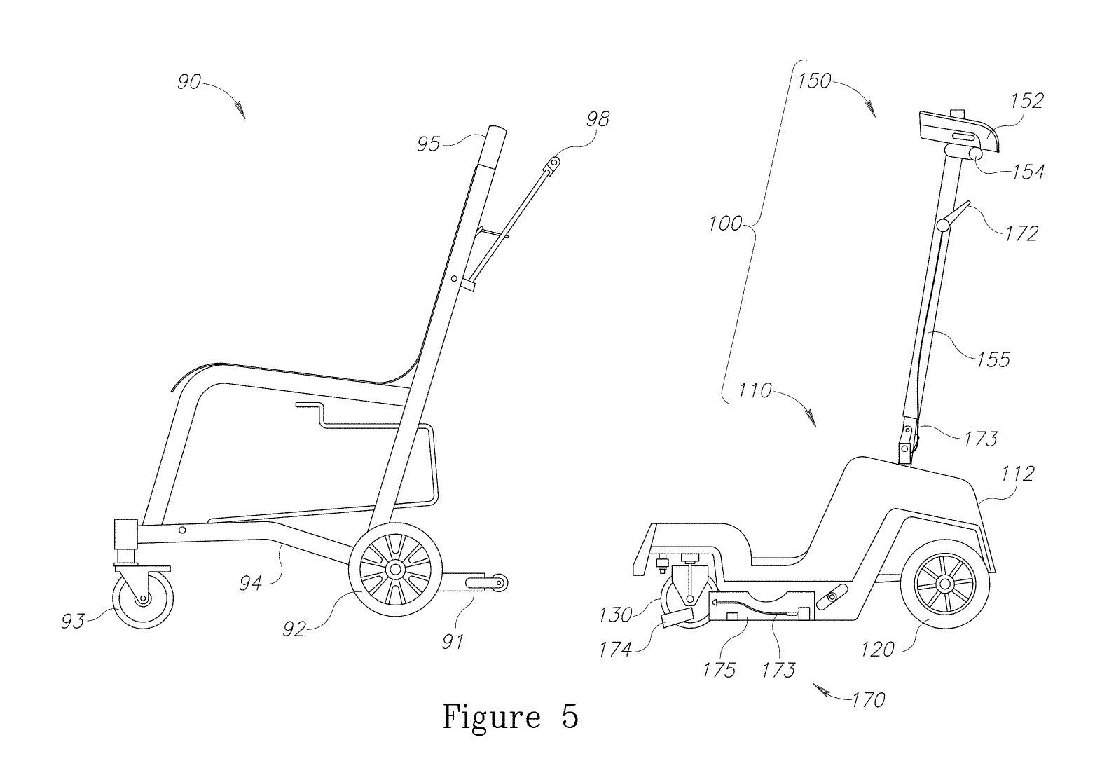

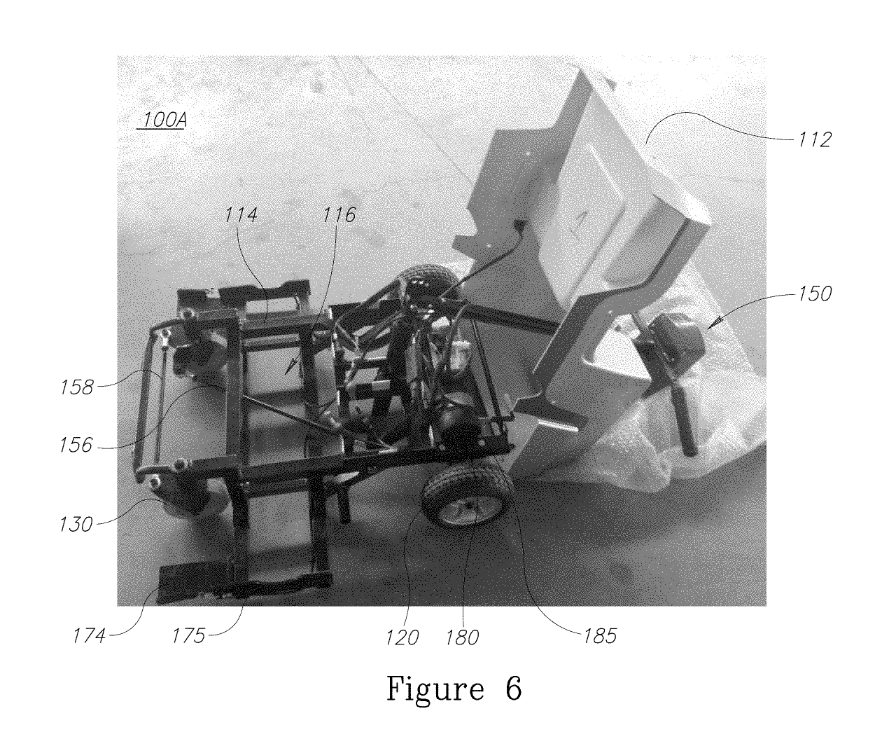

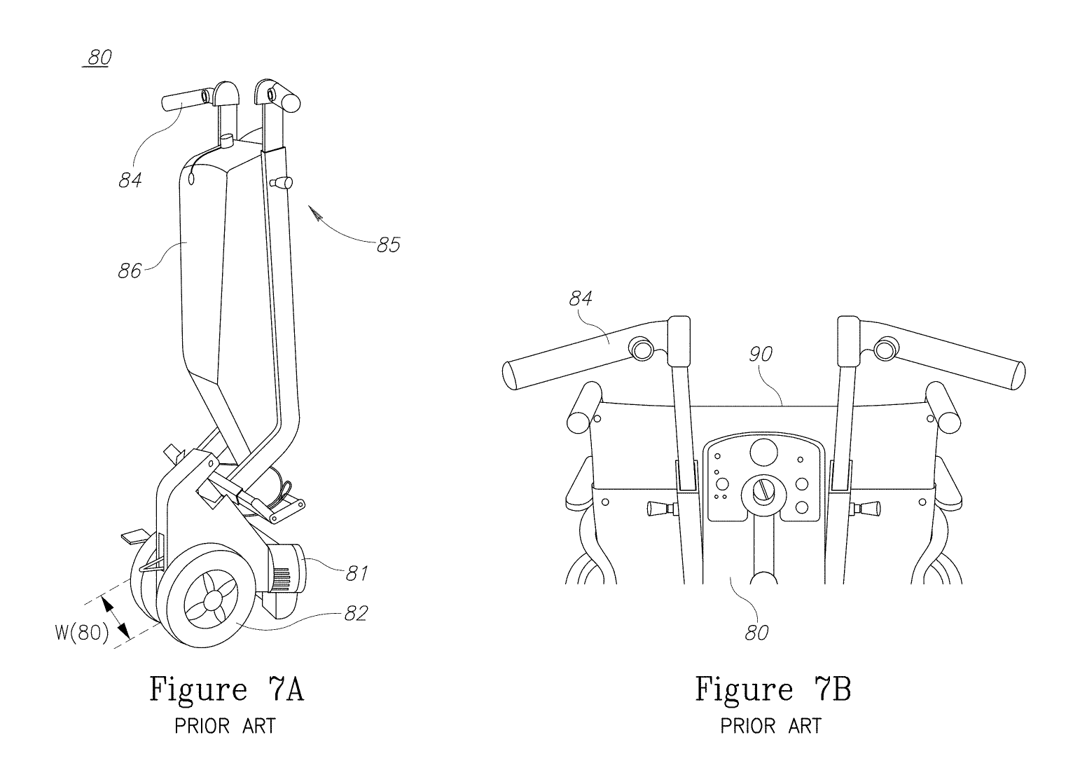

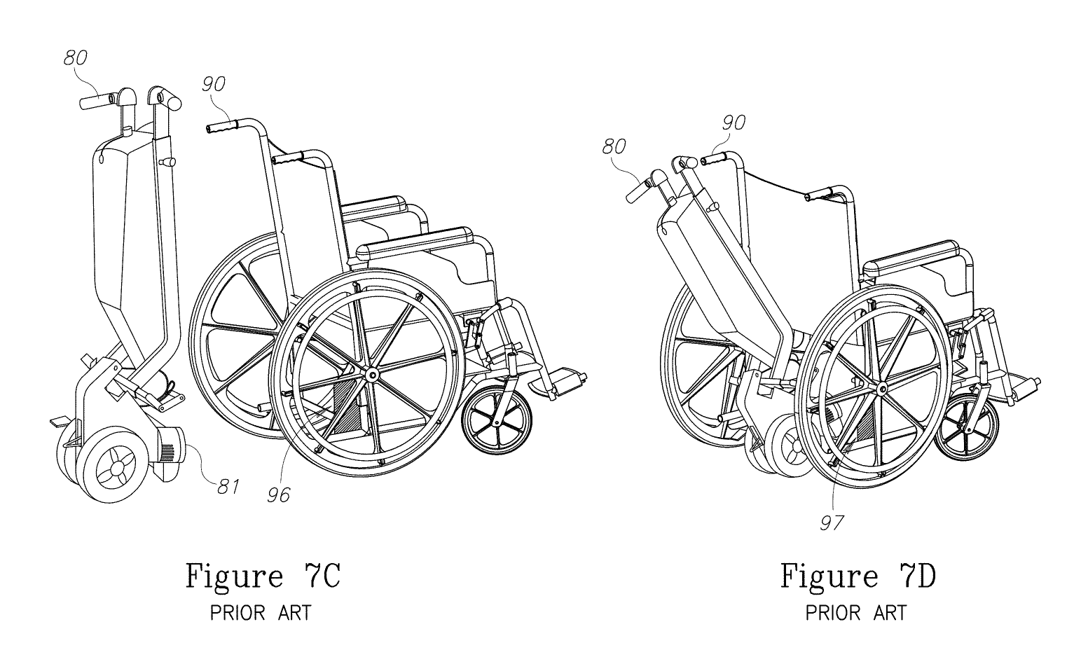

FIG. 1 is a high-level schematic illustration of a carry-on push aid 100 for propelling a wheelchair, according to some embodiments of the invention. FIGS. 2 and 3 are illustrations of carry-on push aid configurations and of a method 200 of using carry-on push aid 100 to propel a wheelchair 90, according to some embodiments of the invention. FIGS. 1-3 provide perspective views of embodiments of carry-on push aid 100. FIG. 4 is a high-level schematic top view illustration of a steering unit 150 of carry-on push aid 100, according to some embodiments of the invention. FIG. 5 is a high-level schematic side view illustration of wheelchair 90 and carry-on push aid 100, according to some embodiments of the invention. FIG. 6 is an illustration of a prototype of carry-on push aid 100 in a non-operational state 100A with opened cover 112, according to some embodiments of the invention. FIGS. 7A-7D illustrate a prior art push aid 80 and its use.

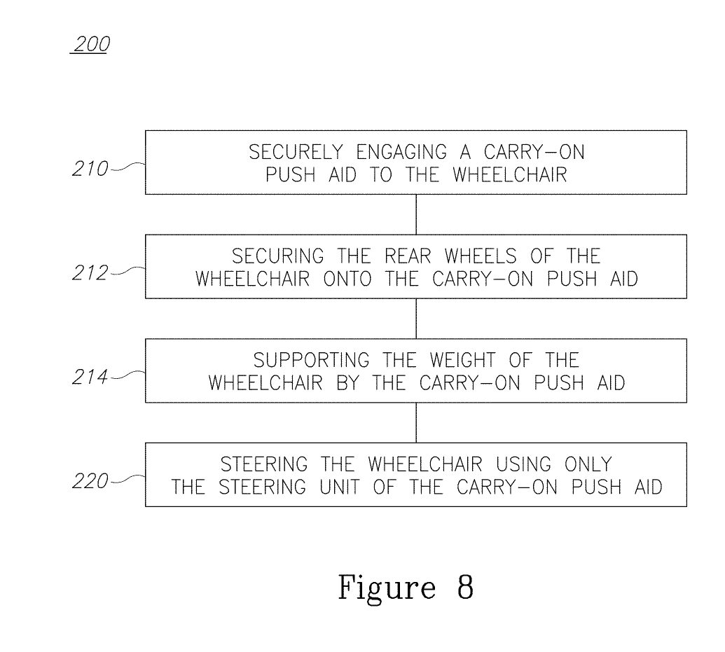

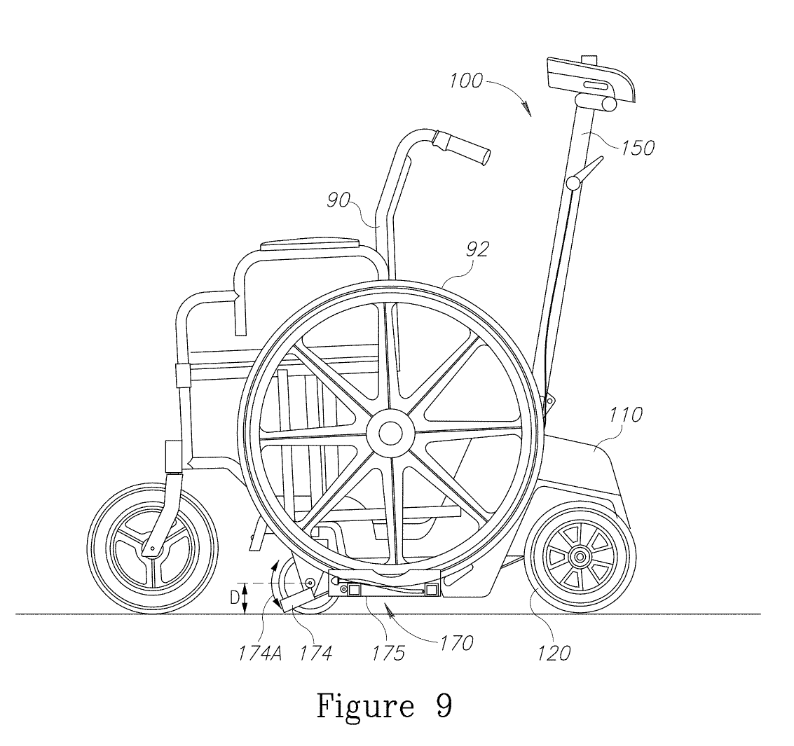

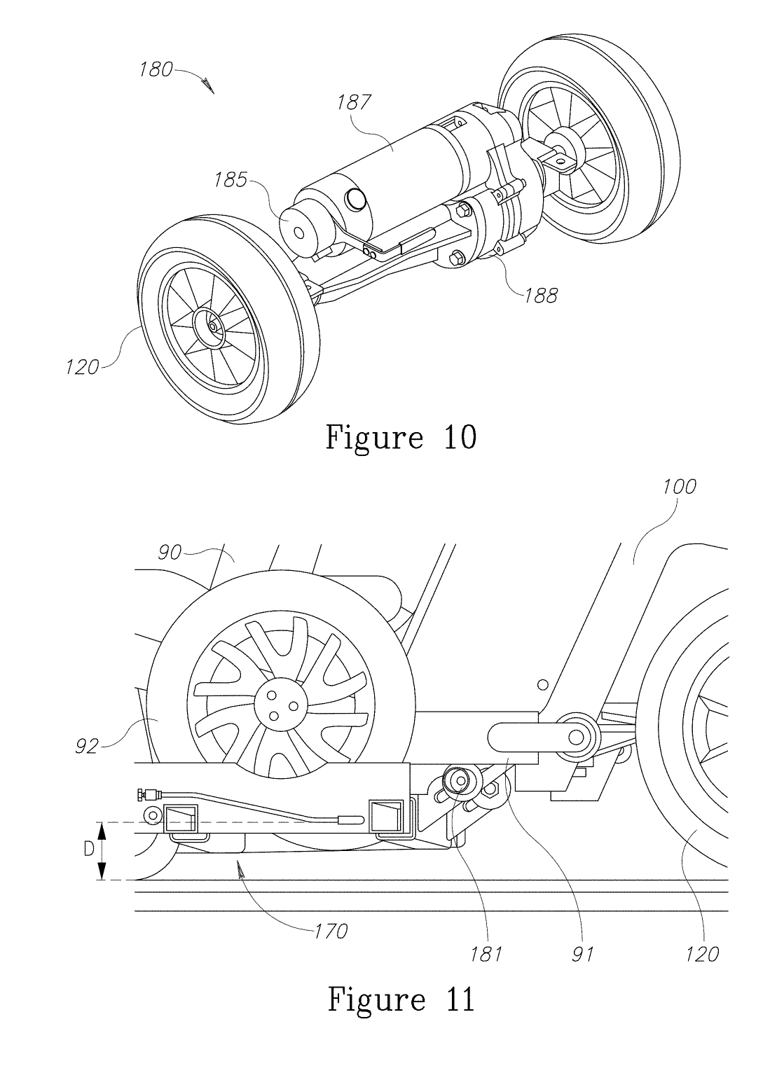

FIG. 8 is a high-level flowchart illustrating method 200, according to some embodiments of the invention. FIG. 9 is a high-level schematic side-view illustration of carry-on push aid 100 propelling large-wheel wheelchair 90, according to some embodiments of the invention. FIG. 10 is a high-level schematic perspective view illustration of a drive unit 180 of carry-on push aid 100, according to some embodiments of the invention. FIG. 11 is a high-level schematic sectional side-view illustration of the secure engagement of wheelchair 90 by carry-on push aid 100, according to some embodiments of the invention.

Carry-on push aid 100 comprises a base 110 comprising at least three wheels 120, 130, which base 110 is configured to securely engage wheelchair 90 as disclosed below. Base 110 further comprises at least one drive unit 180 (see FIGS. 1 and 6 for non-limiting examples) powering at least a powered one 120 of the wheels and steering unit 150 connected to and configured to control at least a steered one 130 of the wheels. Powered wheels 120 are configured to utilize power from drive unit 180 to propel wheelchair 90, while steered wheels 130 are configured to enable steering of wheelchair 90 supported by carry-on push aid 100—via steering unit 150 of carry-on push aid 100, rather than by prior art attachment of push aid 80 to wheelchair 90 and prior art ground-contacting wheelchair 90 and/or using of handles 95 of wheelchair 90.

Some embodiments of method 200 of propelling wheelchair 90 comprise, as indicated schematically by arrows in FIG. 2, securely engaging carry-on push aid 100 to wheelchair 90 (stage 210), e.g., by holding the rear wheels of the wheelchair (stage 212) and supporting the weight of the wheelchair (stage 214), and steering the wheelchair using only steering unit 150 of carry-on push aid 100, rather than by prior art using of handles 95 of wheelchair 90.

Secure engagement of wheelchair 90 by carry-on push aid 100 may comprise using a wheelchair-securing mechanism 170 of base 110, which is configured to engage and/or affix rear wheels 92 of wheelchair 90 to base 110 and to prevent ground contact thereof, as illustrated schematically in FIG. 3. Engagement of wheelchair 90 by carry-on push aid 100 may be carried out prior to seating the patient in wheelchair 90, and be assisted by applying brakes 185 (see, e.g., FIG. 10) on carry-on push aid 100 during the engagement. Indicators and/or additional supports of carry-on push aid 100 may be configured to indicate and ensure, respectively, properly secured engagement of wheelchair 90 onto carry-on push aid 100.

Base 110, in addition to comprising wheelchair-securing mechanism 170, may also be configured to mechanically support wheelchair 90, e.g., by respective configuration of a cover 112 (see FIG. 5) of base 110, possibly configured to at least partly hold and secure a frame 94 of wheelchair 90, and by respective configuration of a frame 114 (see FIG. 6) of carry-on push aid 100, possibly configure to support weights of any of: up to 150 kg, up to 180 kg, up to 200 kg, up to 250 kg or higher weights—enabling the propulsion of heavy patients in wheelchair 90. Possibly, wheelchair 90 may comprise one or more mechanical elements (not shown), configured to support and guide frame 94 of wheelchair 90 into proper position upon base cover 112. Raising wheelchair 90 onto base 110 of push aid 100 may be carried out by mechanical, pneumatic and/or electric elements.

In certain embodiments, wheelchair-securing mechanism 170 comprises two controllably movable wheel flaps 174 attached to two corresponding wheel supports 175. Movable wheel flaps 174 may be configured to controllably guide rear wheelchair wheels 92 onto corresponding wheel supports 175, which may be designed to hold and secure wheels 92, preventing ground contact thereof (see e.g., FIG. 6). Movable wheel flaps 174 may be controlled by a user via levers 172 which are configured to control the movement of flaps 174 via a transmission mechanism 173 (see e.g., FIG. 5), which may be implemented by mechanical, pneumatic and/or electric elements.

In certain embodiments, movable wheel flaps 174 may not be part of wheelchair-securing mechanism 170, especially for use cases in which wheelchair 90 is engaged to and disengaged from carry-on push aid 100 without the patient sitting in wheelchair 90, so that wheelchair 90 may be easily lifted into and out of secure position. In certain embodiments, movable wheel flaps 174 may be configured to be moved by a controllable mechanism, e.g., by a hydraulic mechanism, by the user (e.g. operated by a controller such as levers 172 or alternative controls), e.g., to be used to support movement of wheelchair 90 into and out from secure engagement to carry-on push aid 100. In certain embodiments, movable wheel flaps 174 may be configured to ensure smooth transition of wheelchair 90 into and out from secure engagement to carry-on push aid 100, preventing bumps from affecting a patient in wheelchair 90. In certain embodiments, controllably movable wheel flaps 174 may be further configured to secure rear wheelchair wheels 92 on corresponding wheel supports 175, e.g., by being movable to a vertical position and/or a rear-wheel contacting position (see e.g., FIG. 9). In certain embodiments, wheelchair-securing mechanism 170 may further comprise pins (not shown) configured to secure rear wheelchair wheels 92 on wheelchair-securing mechanism 170.

In certain embodiments, wheelchair-securing mechanism 170 may be adjustable with respect to its width and with respect to the spacing between wheel supports 175 to allow adjustment of wheelchair-securing mechanism 170 to securely engage wheelchairs 90 having a wide range of widths (e.g., between 60 cm and 80 cm) and/or having a wide range of rear wheel diameters (e.g., between 20 cm and 60 cm). For example, wheelchair-securing mechanism 170 may be adjustable by a telescopic mechanism, and see FIG. 9 for an example of carry-on push aid 100 propelling large-wheel wheelchair 90.

In certain embodiments, secure engagement of wheelchair 90 by carry-on push aid 100 requires no adaptation of wheelchair 90, e.g., does not require connecting any adaptor to wheelchair 90, as wheelchair 90 is merely securely engaged by the structure of carry-on push aid 100 and not attached thereto. Examples of prior art attachment of push aid 80 to wheelchair 90 are illustrated schematically in FIG. 7A-7D, employing a connector 81 on push aid 80 attached to an adaptor 96 on wheelchair 90 to form attachment connection 97—and require installing adaptor 96 on wheelchair 90 prior to use and limit the range of wheelchair 90 onto which adaptor 96 may be mounted. It is noted that prior art push aids typically modify wheelchair 90 in one way or another, such as by connecting adaptors, or installing power transition elements directly to wheelchair rear wheels 92. Advantageously, disclosed carry-on push aids 100 may be configured to be operated with unmodified wheelchair 90.

Steering unit 150 may comprise handles 154, a control unit 152, a shaft 155 interconnecting handles 154 to steered wheels 130 in base 110 and transmission elements 156, 158 (see FIG. 6) configured to translate steering movements of handles 154 into corresponding movements of steered wheels 130. In certain embodiments, element(s) 158 such as a bar may interconnect steered wheels 130, and element(s) 156 such as a rod may transmit steering movements or commands to one of interconnect steered wheels 130.

Carry-on push aid 100 may further comprise a stopper 181 configured to engage tip-over prevention element 91 of wheelchair 90 (see FIGS. 1, 2, 5 and 11) and enhance the secure engagement of wheelchair 90 on carry-on push aid 100.

The width of handles 154, indicated as H in FIG. 1, may be ergonomically configured to enable good steering control of carry-on push aid 100 with engaged wheelchair 90, e.g., handle width may be at least the width of wheelchair 90, e.g., 50 cm, 70 cm etc.

Carry-on push aid 100 further comprises controllable brakes 185 (only brake handle is shown in FIG. 6, see also FIG. 10) configured to simplify the engagement of wheelchair 90 to carry-on push aid 100 and ensure safe transportation of the patient on wheelchair, using carry-on push aid 100. Carry-on push aid 100 may be configured to have a free-wheels state for maneuvering obstacles and/or automatic braking in specified scenarios to enhance safety.

Referring to FIG. 4, control unit 152 may comprise, in a non-limiting example, a free-wheel button 161, configured to control brakes 185 of carry-on push aid 100, a speed adjustment knob 162, a power indicator 163, a forward-reverse selector 164, drive push activation buttons 165, a selector for left hand or right hand operation 166, and a battery level monitor 167. In certain embodiments, carry-on push aid 100 may be configured to have a free-wheels mode in which brakes 185 are released and the motor is not operating, for handling engaged wheelchair 90 over rough terrain that requires careful handling. It is noted that activation buttons 165 may be located on both handles, to enable both left-handed and right-handed users to conveniently operate carry-on push aid 100. In certain embodiments, control unit 152 may be configured to automatically apply brakes 185 upon release of activation buttons 165 to further simplify operation of carry-on push aid 100 (even with respect to wheelchairs 90 having a handle 98, see FIG. 5, for implementing brakes upon release).

In certain embodiments, carry-on push aid 100 is configured to hold only rear wheels 92 of wheelchair 90, while leaving front wheels 93 of wheelchair 90 free to rotate (see FIG. 3).

In certain embodiments, base 110 comprises at least four wheels comprising two rear powered wheels 120 and two front steered wheels 130. Certain embodiments comprise drive unit 180 with a single motor (see, e.g., motor 187 in FIG. 10) powering both rear wheels 120, which are interconnected in a mechanical differential configuration, see e.g., FIG. 1). Certain embodiments comprise drive unit 180 with two motors 187, each powering a different rear powered wheel 120, wherein rear wheels 120 are interconnected in a differential drive configuration (not shown), with each motor controlling a different wheel in a coordinated manner, to enable smooth turns. Motor(s) 187 of drive unit 180 may be electric motor(s) powered by electric batteries (e.g., lead acid batteries, lithium ion batteries, etc.), smart motors including control circuitry which coordinates multiple motors to coordinate the movement of powered wheels 130 at turns, hydraulic motors, combinations thereof, or other implementations. Drive unit 180 may comprise corresponding transmission 188 (see e.g., FIG. 10) such as gear(s) configured to deliver the motor power to powered wheels 130. In certain embodiments, motor(s) 187 may be installed on base frame 114, and batteries may be located below cover 112, e.g., at location 116 indicated in FIG. 6. The dimensions of frame 114 and cover 112 may be configured according to the dimensions and configuration of wheelchair 90, and drive unit 180 and batteries may be designed and installed accordingly.

The width of powered wheels 120, indicated as W in FIG. 1, may be configured to enhance the secure engagement of wheelchair 90 to carry-on push aid 100 and provide stability when propelling heavy patients. For example, powered wheels width may be at least the width of wheelchair 90, e.g., 50 cm, 60 cm, 70 cm, etc. In certain embodiments, rear wheels 130 may comprise polyurethane tires, or any other type of traction-providing tires. The configurations of wheels 120 and handles 154 may be optimized with respect to wheelchair configuration 90, to provide easy propulsion and steering of wheelchair, and may optionally be adjustable according to the patient using wheelchair (e.g., according to the patient's weight) and according to the user which controls carry-on push aid 100 to optimize the ease of maneuverability of wheelchair 90.

Advantageously, with respect to prior art push aids 80 which are configured to simplify pushing wheelchair 90 by providing additional propulsion (delivered from an electric motor 86 to wheels 82) via narrow attachment 97 to wheelchair 90, and typically have narrow wheel configurations (W(80) smaller than the wheelchair width, typically with one wheel or two adjacent wheels, 40 cm, 30 cm or less apart) and possibly narrow or no handles 84—some embodiments of the disclosed carry-on push aids 100 have multiple advantages.

It is emphasized that prior art push aids 80 are designed to provide pushing power, but have only a single wheel, two adjacent wheels or no wheels (when delivering power directly to rear wheels 92) in order not to make steering wheelchair 90 cumbersome due to the ground contact of powered wheel(s) 82. Indeed, prior art practice is to reduce the detrimental effect of wheel(s) 82 on steering wheelchair 90, especially as steering transported heavy patients in wheelchair 90 is difficult. Surprisingly, the inventors have found out that steering heavy patients is simpler when powered wheels 130 are spaced apart and with powered wheels 130 replacing rear wheels 82 as ground contacting wheels. The replacement enables moving the steering function from wheelchair 90 (in the prior art) to carry-on push aids 100 (in disclosed embodiments) to solve the problem of transporting heavy patients. As the steering function is moved to carry-on push aids 100, the disclosed carry-on secure engagement of wheelchair 90 onto carry-on push aid 100 suffices and is advantageous with respect to prior art attachment, as disclosed herein.

Some embodiments of carry-on push aid 100 provide secured engagement of wheelchair 90—through having rear and front wheels, 120, 130, respectively, wheelchair-securing mechanism 170 and configuration of supporting frame 114 and base cover 112—and thereby good control of wheelchair 90. Broader wheel spacing (W>>W(80)) and broad handles (H) enable steering of wheelchair 90 even with heavy patients in a comfortable and safe manner. Moreover, providing secure engagement of wheelchair 90 by carry-on push aid 100 rather than prior art attachment of push aid 80 to wheelchair 90 is easily applicable to a wide variety of wheelchairs 90, without requiring any adaptation of wheelchair 90 for use with carry-on push aid 100.

It is noted that elements from FIGS. 1-6 may be combined in any operable combination, and the illustration of certain elements in certain figures and not in others merely serves an explanatory purpose and is non-limiting.

FIG. 8 is a high-level flowchart illustrating method 200, according to some embodiments of the invention. The method stages may be carried out with respect to carry-on push aid 100 described above, which may optionally be configured to implement method 200. Method 200 may comprise the following stages, irrespective of their order. Method 200 may comprise propelling a wheelchair by securely engaging a carry-on push aid to the wheelchair (stage 210), for example by affixing the rear wheels of the wheelchair onto the carry-on push aid (stage 212) and optionally supporting the weight of the wheelchair by the carry-on push aid (stage 214); and steering the wheel chair using only a steering unit of the carry-on push aid (stage 220).

FIG. 9 is a high-level schematic side-view illustration of carry-on push aid 100 propelling large-wheel wheelchair 90, according to some embodiments of the invention. Wheelchair-securing mechanism 170 may be configured and/or be adjusted to receive and securely engage any size of rear wheels 92 of wheelchair 90, as exemplified schematically in FIG. 9. Carry-on push aid 100 is configured to securely engage rear wheels 92 of wheelchair 90 while preventing ground contact thereof, as illustrated schematically by distance D maintained by wheelchair-securing mechanism 170 between wheelchair rear wheels 92 and the ground. Movable wheel flaps 174 may be configured to controllably guide and enable securing rear wheelchair wheels 92 onto corresponding wheel supports 175, as indicated schematically by the thick arrow 174A, indicating possibly controllable movement of movable wheel flaps 174 after wheelchair 90 has been mounted onto wheel supports 175 of carry-on push aid 100, which holds and secures wheelchair 90 and/or prevents release thereof from wheel supports 175 of carry-on push aid 100.

FIG. 10 is a high-level schematic perspective view illustration of a drive unit 180 of carry-on push aid 100, according to some embodiments of the invention. Drive unit 180 may comprise motor 187 connected to powered wheels 120 via differential drive 188 configured to control power transmission and differential wheel movements in turns. Brakes 185 may be controlled according to various schemes, including e.g., manual control (see handle), automatic braking upon various conditions (e.g., release of activation button, upon mounting of wheelchair 90 onto carry-on push aid 100, etc.) and free-wheel configuration under specified conditions (e.g., activation to move over obstacles or rough ground).

FIG. 11 is a high-level schematic sectional side-view illustration of the secure engagement of wheelchair 90 by carry-on push aid 100, according to some embodiments of the invention. FIG. 11 illustrates the secure engagement preventing ground contact of wheelchair 90, indicated by the distance D, and the configuration of stopper 181 which engages tip-over prevention element 91 of wheelchair 90—to prevent its backwards tilting—and enhances the secure engagement of wheelchair 90 on carry-on push aid 100.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A carry-on push aid for propelling a wheelchair, the carry-on push aid comprising:
a base comprising at least three wheels and at least one drive unit powering at least a powered one of the wheels, wherein the base is configured to securely engage the wheelchair and to mechanically support the wheelchair, and
a steering unit connected to and configured to control at least a steered one of the wheels.

2. The carry-on push aid of claim 1, wherein the base comprises a wheelchair-securing mechanism configured to support and secure rear wheels of the wheelchair and to prevent ground contact of the rear wheels of the wheelchair.

3. The carry-on push aid of claim 2, wherein the wheelchair-securing mechanism comprises two controllably movable wheel flaps attached to two corresponding wheel supports, wherein the movable wheel flaps are configured to controllably guide the rear wheelchair wheels onto the corresponding wheel supports.

4. The carry-on push aid of claim 3, wherein the controllably movable wheel flaps are further configured to secure the rear wheelchair wheels on the corresponding wheel supports.

5. The carry-on push aid of claim 2, wherein the wheelchair-securing mechanism further comprises pins configured to secure the rear wheelchair wheels on the wheelchair-securing mechanism.

6. The carry-on push aid of claim 1, wherein a cover of the base is further configured to affix the wheelchair thereto.

7. The carry-on push aid of claim 1, wherein the base comprises at least four wheels comprising two rear powered wheels and two front steered wheels.

8. The carry-on push aid of claim 7, wherein the at least one drive unit comprises a single motor powering both rear wheels, and wherein the two rear powered wheels are interconnected in a mechanical differential configuration.

9. The carry-on push aid of claim 6, wherein the at least one drive unit comprises two motors, each powering a different rear powered wheel, wherein the rear wheels are interconnected in a differential drive configuration.

10. The carry-on push aid of claim 1, further comprising a stopper configured to engage a tip-over prevention element of the wheelchair to enhance the secure engagement of the wheelchair in the carry-on push aid.

11. A method of propelling a wheelchair comprising:
securely engaging a carry-on push aid to the wheelchair and mechanically supporting the wheelchair by the carry-on push aid, and
steering the wheel chair using only a steering unit of the carry-on push aid.
